(19) United States
(12) Patent Application Publication
(10) Pub. No.: US 2019/0057401 A1
(43) Pub. Date: Feb. 21, 2019

(54) IDENTIFYING MARKET-AGNOSTIC AND MARKET-SPECIFIC SEARCH QUERIES

(71) Applicant: Microsoft Technology Licensing, LLC, Redmond, WA (US)

(72) Inventors: Architha Subramanya, Bellevue, WA (US); Prateek Tiwari, Sammamish, WA (US)

(73) Assignee: Microsoft Technology Licensing, LLC, Redmond, WA (US)

(21) Appl. No.: 15/680,148

(22) Filed: Aug. 17, 2017

(51) Int. Cl. G06Q 30/02; G06F 17/30

(52) U.S. Cl. CPC G06Q 30/0201; G06F 17/30864

(57) ABSTRACT

Methods and systems to automatically identify market-agnostic and market-specific search queries are provided. Features of a received search query are analyzed and signaling associated with those features is ranked in terms of its strength in identifying the query as market-agnostic versus market-specific. A relevance score is generated for the received search query based on the feature rankings. The features and relevance score for the search query are used by a binary classifier for classifying and labeling each search query as market-agnostic or market-specific. Thus, search results may be returned and processed for market-agnostic search queries without the need, cost, and inefficiency of processing for every different market.

### BACKGROUND

In a typical computing environment, users perform Internet searches for a variety of information for work, education and leisure. Internet searches are primarily performed using one or more Internet search engines that allow entry of a search query for commencing a search. Search queries can be structured by users according to an almost limitless assembly of words, phrases, terms, statements, questions, and the like. Depending on the phrasing or words/terms used, a search query may be more or less market-agnostic or a search query may be more or less market-specific. For example, a search query like “What is the average starting salary of a teacher in the United States?” is market-agnostic because such a search phrase can be a valid search query emanating from any locale, market or search domain in the world, for example, where a teacher from one country is interested in teacher salaries in other countries (e.g., the United States). On the other hand, a search query like “What is the average starting salary of a teacher?” is market-specific because such a query may return hundreds, thousands or more results for every area in the world in which teachers are employed. Thus, in such a case, those search results that are associated with data outside the locale or market of the searching user need to be suppressed in order to give the search results meaning.

Developers of search engines and search results associated with different types of search queries must spend significant searching and analysis time, computer processing and data storage for receiving and separating search results associated with different types of search queries (e.g., market-agnostic and market-specific) for developing search engines that will provide appropriate and desirable results to searching users. A problem arises because either type of search query may return enormous amounts of search results data that are not responsive to the user's query. Return and processing of such search results cause significant searching costs, data storage, computing resources and search engine/search results development productivity. Thus, a need exists for methods, systems and devices for identifying market-agnostic and market-specific search queries so that market-agnostic search queries may be easily and efficiently separated from market-specific search queries.

It is with respect to these and other considerations that the present disclosure is provided.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

The above and other problems are addressed by methods, systems and computer storage devices for automatically identifying market-agnostic and market-specific search queries. Features of a received search query are analyzed and signaling associated with those features is ranked in terms of its strength in identifying the query as market-agnostic versus market-specific. A relevance score is generated for the received search query based on the feature rankings. The features and relevance score for the search query are used by a binary classifier for classifying and labeling each search query as market-agnostic or market-specific. Thus, search results may be returned and processed for market-agnostic or market-specific search queries without the need, cost and inefficiency of processing for every different market.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a simplified block diagram showing an example operating environment for identifying market-agnostic and market-specific search queries;

FIG. 2 is a simplified block diagram showing an example system for identifying market-agnostic and market-specific search queries;

FIG. 3 is a flow chart showing general stages involved in an example method for automatically identifying market-agnostic and market-specific search queries;

FIG. 4 is a simplified block diagram illustrating example physical components of a computing device;

FIGS. 5A and 5B are simplified block diagrams of a mobile computing device; and

FIG. 6 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

As briefly described above, aspects of the present disclosure are directed to automatically identifying market-agnostic and market-specific search queries. Features of a received search query are analyzed and signaling associated with those features are ranked in terms of their strengths in identifying the query as market-agnostic versus market-specific. A relevance score is generated for the received search query based on the feature rankings. The features and relevance score for the search query are used by a binary classifier for classifying and labeling each search query as market-agnostic or market-specific. Thus, search results may be returned and processed for market-agnostic search queries without the need, cost and inefficiency of processing for every different market.

According to aspects, when a search query is received and processed by a search engine, a determination that two or more results are the same across different markets or domains and the degree of overlap of such results are passed as a signal to a signal ranker for ranking the signaling in terms of its strength in determining whether the search query is market-agnostic or market-specific. If the search query contains an explicit location, or otherwise mentions or identifies a location, a tagged or determined location may indicate that the query is market-agnostic, and data representing the location is likewise passed as a signal to the signal ranker. Search domains responsive to the search query may be ordered, and signaling associated with domain ordering may be passed to the signal ranker. In addition, information on user selection of search results (e.g., click analysis) may similarly be passed to the signal ranker for aiding in the identification of market-agnostic queries to allow such queries to be separated from market-specific queries.

After each of the features of a given search query are ranked, a relevance score is generated for the search query by a relevance score engine. The features and relevance score for the search query are fed into a search query classifier (e.g., binary classifier). If the relevance score for the search query meets a threshold level, the query may be identified as either market-agnostic or market-specific, and the search query may be used for either a market-agnostic search or a market-specific search, as required, to prevent needless processing, storage and search query development caused by inclusion of results from both types of searches in a subsequent search performed by a user.

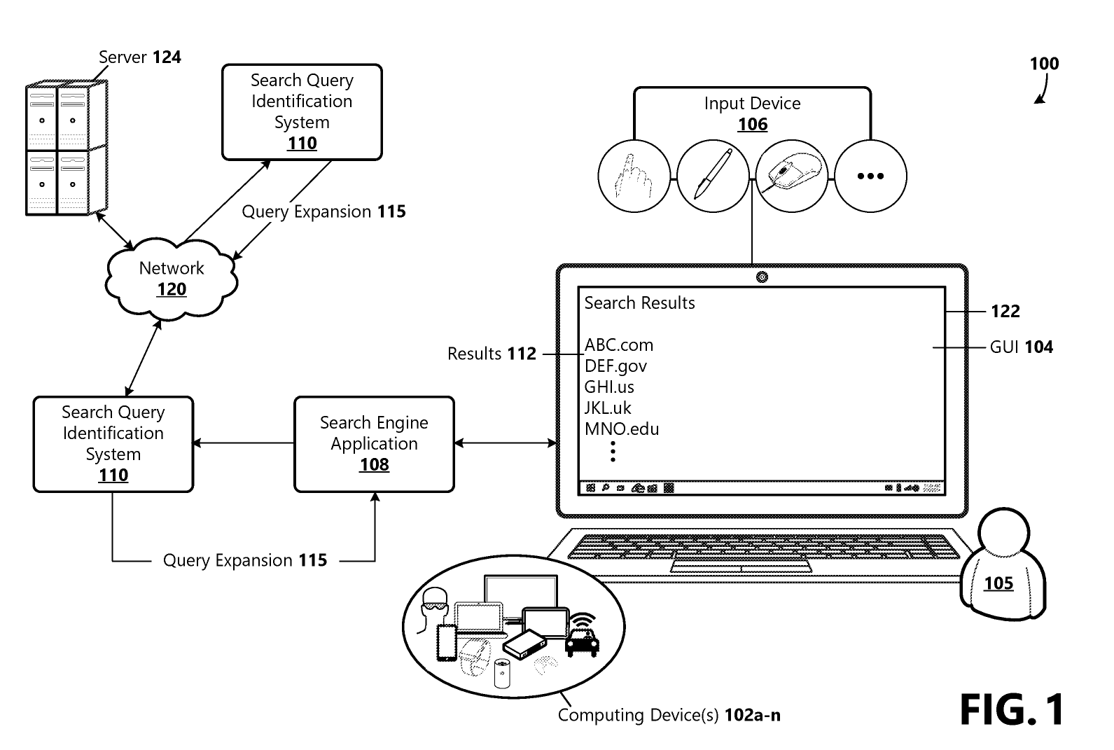

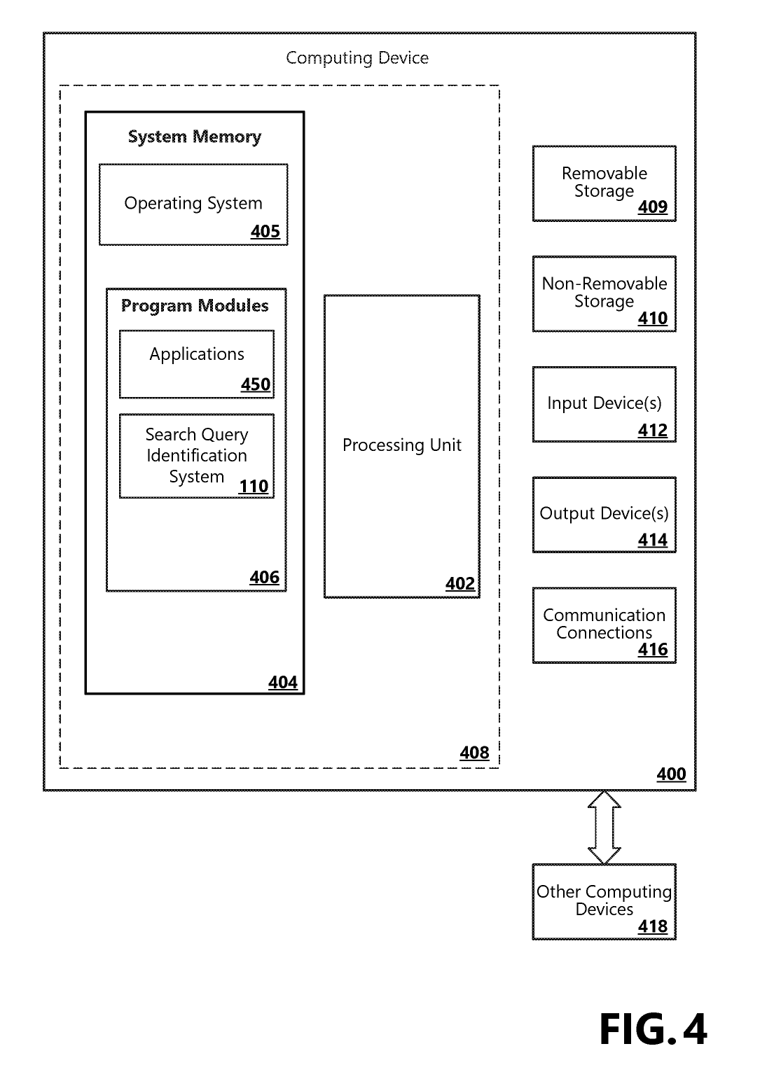

With reference now to FIG. 1, a block diagram of an example operating environment 100 illustrating aspects of an example system for automatically identifying market-agnostic and market-specific search queries is shown. The example operating environment 100 includes an electronic computing device 102. The computing device 102 is illustrated as a laptop computing device; however, as should be appreciated, the computing device 102 may be one of various types of computing devices (e.g., a tablet computing device, a desktop computer, a mobile communication device, a laptop/tablet hybrid computing device, a large screen multi-touch display, a gaming device, a smart television, a wearable device, or other type of computing device) for executing applications 108 for performing a variety of tasks. The hardware of these computing devices is discussed in greater detail in regard to FIGS. 4, 5A, 5B, and 6.

A user 105 may use an application 108 on the computing device 102 for a variety of tasks, which may include, for example, to write, calculate, draw, take and organize notes, organize and prepare presentations, send and receive electronic mail, make music, perform Internet searches, and the like. Examples of suitable applications 108 include, but are not limited to, word processing applications, spreadsheet applications, slide presentation applications, electronic mail applications, drawing applications, note-taking applications, web browser (Internet search engine) applications, and game applications. Applications 108 may include thick client applications 108, which are stored locally on the computing device 102, or may include thin client applications 108 (i.e., web applications) that reside on a remote server 124 and accessible over a network 120. A thin client application 108 may be hosted in a browser-controlled environment or coded in a browser-supported language and reliant on a common web browser to render the application 108 executable on the computing device 102.

According to examples, the application 108 is a program that is launched and manipulated by an operating system, and manages content 112 published on a display screen 122. Aspects of the application(s) 108 are operative or configured to generate and provide a graphical user interface (GUI) 104 that allows a user 105 to interact with application functionality and electronic content. In various examples, the GUI 104 includes a toolbar, comprising various tools and settings related to authoring and using the content.

In examples, the application 108 receives input from the user 105, such as text input (e.g., search queries), drawing input, inking input, etc., via various input methods, such as those relying on mice, keyboards, and remote controls, as well as Natural User Interface (NUI) methods, which enable a user 105 to interact with a device in a “natural” manner, such as via speech recognition, touch and stylus recognition, gesture recognition both on screen and adjacent to the screen, air gestures, head and eye tracking, voice and speech, vision, touch, hover, gestures, and machine intelligence.

According to aspects of the present disclosure, the application 108 is an Internet search engine application 108 operative or configured to receive one or more search queries in the form of a variety of words, phrases, terms, statements, questions, and the like for initiating an Internet-based search for information associated with the entered search query. Non-limiting examples of search engine applications 108 include BINGO from MICROSOFT CORPORATION and GOOGLEO from ALPHABET, INC. As illustrated in FIG. 1, as a result of the operation of the search engine application 108 wherein a search query is entered and used for commencement of a search, a graphical user interface 104 associated with the search engine application 108 may be provided in the computer display 122, and search results content 112 may be displayed in the graphical user interface 104 responsive to the entered search query.

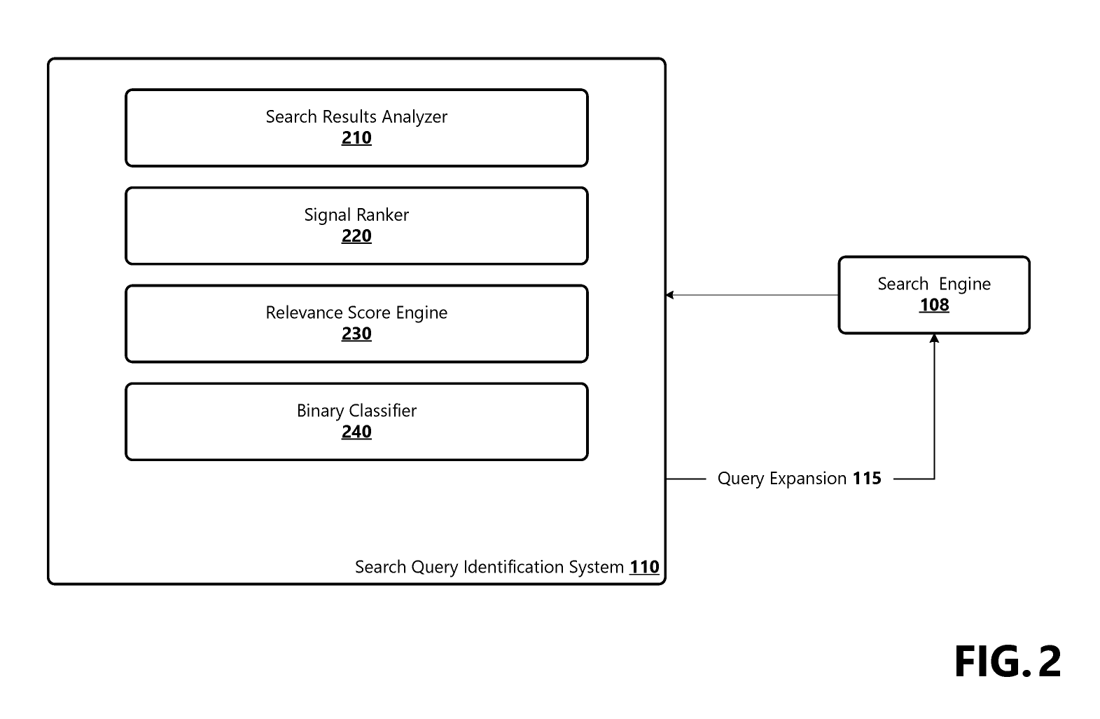

Referring still to FIG. 1, a search query identification system 110 is illustrative of a software application, module, device or system operative or configured to analyze received search queries and to identify received search queries as market-agnostic or market-specific, as described herein. Operation of the search query identification system 110 is described in detail below with reference to FIG. 2. The query expansion 115 is illustrative of an in-market query expansion to capture different forms of the same localized query which is valid in each market. As illustrated in FIG. 1, the search query identification system 110 may operate on the client side of the network 120 wherein the search query identification system 110 is communicatively accessible by the search engine application 108. Alternatively, the search query identification system 110 may operate on the server side in association with the server 124 wherein the search query identification system 110 is accessible to the search engine application 108 via the network 120.

FIG. 2 is a simplified block diagram showing an example system for identifying market-agnostic and market-specific search queries. When the developer of the search engine application 108 designs the search engine application 108 to receive a variety of different types of search queries, the developer must use one or more ranking algorithms for ranking results responsive to search queries. In such a ranking process, if the developer must contend with search results responsive to both market-agnostic and market-specific search queries, then the data storage, computing processing, and developer productivity is rendered inefficient and costly as opposed to the efficiency and cost associated with processing search results to search queries identified as market-agnostic or market-specific before search results are returned. As used herein, market-agnostic includes, but is not limited to, those search queries that are generic or agnostic with respect to the locale, market or search domain associated with the querying user 105 where such a market-agnostic search query is a valid search query for returning results from any locale, market, or search domain associated with the querying user 105. Alternatively, a market-specific search query is a search query where meaningful search results are dependent upon the search query being applied to a specific market, locale or search domain associated with the querying user 105.

As briefly described above, according to aspects of the present disclosure, search queries are identified and classified as market-agnostic or market-specific, and the classification may be used for separating a market-agnostic search query from a market-specific search query for reducing the volume, storage requirements, processing requirements, and developer activity requirements associated with search results responsive to both types of search query. For example, a query such as “What are the tax rates in the United States?” is market-agnostic because it is a valid search query from any market or search domain in the world. A searching user 105 may present such a search query in any market and to any search domain from any location in the world where the searching user 105 is interested in the desired information regardless of the searching user's location. That is, a searching user 105 presenting this example search query may be interested in the tax rates in the United States regardless of the user's present, temporary or permanent location. Thus, this example search query is generic or agnostic with respect to the locale of the searching user 105. On the other hand, a search query of “What are my tax rates?” is not market-agnostic, and results from such a query need to be suppressed outside the current market or locale of the querying user 105. Otherwise, the querying user 105 may receive search results for hundreds or even thousands of locales, for example, taxing entities with differing tax rates where information associated with markets or locales outside of the requesting user's market or locale likely will be irrelevant to the user's desired search results.

Referring then to FIG. 2, the search query identification system 110, as briefly described above with reference to FIG. 1, is operative or configured to identify and classify a search query as either market-agnostic or market-specific based on analysis of and relevance ranking/scoring for a given search query. Referring to the search query identification system 110, the search results analyzer 210 is a software application, module, device or system operative or configured to analyze a received search query for aiding in the identification and classification of a received search query as a market-agnostic or market-specific query. According to aspects, the search results analyzer 210 may determine whether search results returned from two or more markets or domains for a given search query has a degree of overlap indicating that the search query may be market-agnostic. That is, if search results for a given search query return the same or similar results from two or more markets or search domains, the degree of overlap may be passed to the binary classifier 240 (described below) as a signal for determining the type associated with the received search query.

In addition, the search results analyzer 210 may also determine whether the search query includes one or more location entities, for example, a specific location, the mentioning of a location, or information indicative of a location that may serve as a positive signal that the search query is market-agnostic or may serve as a negative signal that the search query is market-specific. For example, referring back to the previous example query of “What are tax rates in the United States?” the phrase “United States” may be used by the search results analyzer 210 as an indication that the search query is a market-agnostic query.

As should be appreciated, the received search query may be processed according to a natural language processor or other text parser for passing components of the received search query to a dictionary or other word, phrase, or textual content repository for determining whether one or more components of the received search query may be identified as a specific location. For example, in addition to such specific locations as the “United States,” “United Kingdom,” “France,” and the like, other components of a received query, for example, a zip code identifiable region, state, city, municipality and the like may be identified as associated with a specific location.

If a location is identified in a received query, then tagged entities or components in the received search query identified as associated with a location may be passed to the binary classifier 240, described below, as a signal indicating that the received search query is market-agnostic. On the other hand, where no components or entities of the received search query are identified as associated with a location, then the lack of identification of a location in the received search query may be passed to the binary classifier 240 as a negative signal indicating that the received search query may be market-specific where search results responsive to the received search query associated with markets, locales, or search domains outside the requesting user's market, locale, or search domain may be suppressed as described herein.

In addition, the search results analyzer 210 may order various search domains through which results responsive to the received search query are obtained. Such ordering of various domains may similarly be passed as a signal to the binary classifier 240 for indicating whether a query is strongly generic or market-agnostic or whether the search query is market-specific. For example, if search results responsive to a given search query return search results widely or evenly distributed across multiple search domains, where none of the search domains are determined as authoritative or predominant relative to other search domains, such information may indicate and serve as a signal to the binary classifier that the received search query is market-agnostic or generic relative to a specific market or locale associated with the requesting user. For example, if search results responsive to a given search query are widely or evenly distributed across a .us domain, a .uk domain, a .com domain, a .net domain, a .edu domain, and the like, such information may indicate that the search query is a valid search query in any market or locale. On the other hand, if search results responsive to the received query indicate or illustrate an identifiable ordering where domains may be ordered in terms of domain prominence, then that ordering information may be used as a signal to the binary classifier 240 for identifying the received search query as market-agnostic or market-specific.

For example, if search results responsive to the received search query are predominantly from a .us search domain followed by lesser responsiveness from a .uk search domain, and so on, then the search domains associated with the returned results may be ordered, and information associated with the predominant search domain may be passed to the binary classifier 240 as an indication that the received query is specific to a locale or market associated with the predominant or higher ranking domain. Where research results responsive to the received query are widely or evenly distributed among a number of search domains, then information may be passed as a signal to the binary processor indicating that the received search query is market-agnostic.

The search results analyzer 210 is also operative or configured to analyze user interaction with a received search result (e.g., click analysis) for further determining whether a received search query is market-agnostic or market-specific. That is, a user selection, for example, a click on a search result is a strong signal to indicate the user's satisfaction and intent with respect to the selected search result. For example, after the user 105 enters a query such as “What are tax rates in the United States?”, if the user 105 clicks on or otherwise selects a specific search result in response to the entered search query, the user's selection of that result is indicative of the user's satisfaction with that result as a correct result to the user's search query and is indicative of the user's intent with respect to the information associated with the received result. For example, if a query in EN-GB results in a user selection or click on a “gov.uk” domain while a query in EN-US results in a user interaction or click on a “gov.us” domain, then a strong signal may be passed to the binary classifier 240 to suppress results for the EN-GB not associated with the “gov.uk” domain and similarly for the “gov.us” domain. For another example, if the aforementioned search query of “What are my tax rates?” returns search results from three different search domains, and a user 105 clicks on or otherwise selects one or more search results from a specific one of the domains from which search results are returned, then a signal may be passed to the binary classifier 240 indicating that the received search query may be market-specific in association with markets or locales particular to the domain associated with the user's selections.

Referring still to FIG. 2, the signal ranker 220 is a software application, module, device, or system operative or configured to rank the signals received from the search results analyzer 210, as described above. For example, if a given search result returns an identical result across ten markets or domains, the signal from the search results analyzer 210 for the degree of overlap between the markets and/or domains may be ranked very high owing to the strong degree of overlap. On the other hand, if a similar result is returned from two markets or domains, but a similar or same result is not returned from other markets or domains, the ranking for the associated signal may be significantly lower. Likewise, if a specific location, for example, a specific city, state, country, specific zip code, and the like is tagged in a received search query, then a signal associated with the tagged location entity may be ranked very high on a given ranking scale, for example, a scale from one to ten, where ten is the highest ranking. On the other hand, where information contained in a search query, for example, the term “Madison” may be indicative of a location, for example, Madison, Wis., or the term may be indicative of a person's name, then the signal ranker 220 may assign a relatively low ranking for the signal associated with the word or term “Madison” as compared to another piece of information that is more particular to a specific location.

In terms of domain ordering, if signals returned from the search results analyzer 210 for domain ordering indicates that one search domain is significantly more predominant than all other search domains from which results were returned, the signal associated with domain ordering may receive a high ranking by the signal ranker 220. On the other hand, if the domain ordering indicates that a number of domains are relatively close in ordering owing to search results being more widely or evenly distributed between the search domains, then signaling associated with search domain ordering may receive a relatively low ranking.

Likewise, in analyzing user selection or clicking on one or more search results, signaling associated with repeated user selection of a given search result may receive a significantly higher signal ranking than signaling associated with a search result clicked-on or otherwise selected by the user but having a very low associated dwell time, for example, less than five seconds. That is, if a user selects a given search result and then immediately moves to a different search result, the small amount of dwell time on the selected search result may be used as part of the signaling and may result in a lower signal ranking.

Referring still to FIG. 2, the relevance score engine 230 is a software application, module, device or system operative or configured to generate a relevance score for each analyzed search result that may accompany the signals for the search result for aiding in classification and/or identification of the associated search query as market-agnostic or market-specific. For example, the relevance score engine may take each of the rankings applied to each received signal and may generate an overall score for a given search query. For example, if a given search query receives a high signal ranking for overlap of results between a number of markets or domains, a very low ranking for domain ordering indicating that the search results for the search query are widely or evenly distributed among a variety of search domains, a high ranking or inclusion of specific location entities, and a ranking indicating that the user selects or clicks on results across a variety of markets or search domains, these rankings may result in a very high relevance score from the relevance score engine 230 indicating that the search query is a market-agnostic query.

On the other hand, if a query results in very little overlap between markets or domains, does not include one or more location entities indicating a particular location, has a high signal ranking associated with a very predominant or highly ordered search domain and receives high signal ranking for user selections or clicks associated with a particular market or domain, then a very high relevance score may be generated indicating that the search query is a market-specific search query. Alternatively, if the relevance score generated for the search query is in the middle of the relevance score ranking, such a relevance score may result in difficulty in ultimately identifying or classifying the search query as either market-agnostic or market-specific.

In some cases, a particular signal may be so strong relative to other signals that it may cause a high relevance score for the search query notwithstanding the strength of other signals. For example, if the query includes a very specific location, for example, as found in the phrase “What is the population of Seattle, Wash.,” the specific and particular nature of the location entities in the received search query may cause a very high relevance score notwithstanding other signals associated with the received search query such that the received search query may be identified as a market-agnostic query because the question of the population of Seattle, Wash. may be entered and used as a valid search query in any market or through any search domain in the world.

Referring still to FIG. 2, the binary classifier 240 is illustrative of a software application, module, device or system operative or configured to receive the signaling associated with the analyzed search query along with the relevance score generated for the search query for identifying or classifying the received search query as either market-agnostic or market-specific. As should be understood by those skilled in the art, a binary classifier 240 is a well-known classification, application, module, device, or system for identifying, labeling, or otherwise deciding between two pieces of data. According to the present disclosure, the binary classifier 240 is responsible for deciding whether a given search query is either market-agnostic or market-specific, as described herein. According to aspects, based on the signaling received from the search results analyzer 210 and the relevance score received from the relevance score engine 230, the binary classifier 240 may label the received search query as either market-agnostic or market-specific. That is, if the relevance score meets or exceeds a prescribed threshold score in association with other features (and associated signaling) for a received query, then the query may be classified as market-agnostic or market-specific, as required.

According to aspects of the present disclosure, the binary classifier 240 may assign a confidence score to its classification of individual received search queries. For example, if the signaling received for a given search query along with the received relevance score is highly indicative that the received search query is indeed a market-agnostic query, then the binary classifier may label the received search query as such. On the other hand, if the relevance score received from the relevance score engine is in the middle of the relevance score range, for example, 0 to 100, and if signaling from the search results analyzer 210 is not dispositive for example, a very low degree of overlap between multiple markets in association with a location entity indicating a very specific location, then the inability to identify or classify the associated search query as either market-agnostic or market-specific may result in the binary classifier labeling the received search query as indeterminate which may require manual intervention by a developer for finalizing a determination with respect to the received search query.

If a given search query is identified or classified by the binary classifier 240 as market-agnostic or generic over various markets or domains, a process for query expansion 115 may be used for performing in-market query expansion to capture different forms of the same query which is valid in each market. For example, if a given search query is classified as a market-agnostic query, then the process for query expansion 115 may be used for generating different forms (e.g., different phrasing, query structure, query terms, etc.) of the same query which will be valid in each market in which the market-agnostic or generic query may be used for returning search results.

As illustrated in FIG. 2, the search query classification results of the search query identification system 110 including query expansion, where applicable, are returned back to the search engine 108 for improving the performance of the search engine 108 relative to the classification of the received search query. That is, if a given search query is classified as a market-agnostic search, then it may be separated from similar searches that are market-specific so that needless search results, data storage, computing processing, and developer intervention may be avoided. As should be appreciated, avoiding such needless storage, processing, and developer activity results in a significantly more efficient search engine application operation, and results in a much more efficient computing system 102 with which the search engine application 108 is operated.

Having described an example operating environment for aspects of the present disclosure with respect to FIGS. 1 and 2, FIG. 3 is a flow chart showing general stages involved in an example method for automatically identifying market-agnostic and market-specific search queries. The method 300 begins at start operation 305 and proceeds to operation 310 where a search query is received at the search engine application 108. For example, a search engine application developer or user may enter a search query for returning a variety of search results from one or more search domains responsive to the search query. A search query may include a phrase that may be later determined to be a market-agnostic search query, for example, “What are tax rates in the United States?” or a search query may include a phrase that may be later determined to be a market-specific query such as “What are my tax rates?”, or a search query may include terms, words, or phrases that may not be classified or identified as either market-agnostic or market-specific, as described above with reference to FIG. 2. At operation 315, in response to the received search query at the search engine application 108, one or more search results content 112 are returned as illustrated in the graphical user interface 104, illustrated in FIG. 1.

At operation 320, the received search query and the search results content 112 are passed to the search query identification system 110, as illustrated and described with reference to FIGS. 1 and 2 above. At operation 320, a determination is made as to whether there is overlap of results terms between two or more markets or domains, and a determination as to the degree of overlap of any overlapping terms is similarly determined, as described above with reference to FIG. 2. For example, as described above, if the same or similar results are returned from two or more markets and/or domains, signaling associated with the degree of overlap is passed to the signal ranker 220 for ranking, as described above with reference to FIG. 2.

At operation 325, a determination is made as to whether the received search query includes location entities, for example, specific locations such as cities, states, countries, addresses, zip codes, and the like, or whether the received search query includes language that may be determined to be associated with a given location. Words or phrases contained in the search query that are determined to be locations or associated with locations based on an analysis of the text contained in the received search query, as described above, are tagged, and signaling associated with the tagged location entities is passed to the signal ranker 220 as described above.

At operation 330, one or more search domains from which search results are returned responsive to the received search query are ordered by the search results analyzer 210 based on the strength of the domains relative to the returned results. For example, if one search domain returns more search results than a second search domain, then the first domain will be ranked higher than the second domain, and so on. Signaling associated with the ordering of search domains and associated markets is passed to the signal ranker 220, as describe above with reference to FIG. 2.

At operation 335, developer and/or user selection of particular search results, for example, user 105 clicking on particular search results and information related to user behavior with respect to selected or clicked-on search results, for example, dwell time on a selected search result is passed as a signal to the signal ranker 220, as described above with reference to FIG. 2.

At operation 340, each of the signals received from the search results analyzer 210 at operations 320, 325, 330, 335 are passed through the signal ranker 220 for ranking, as described above with reference to FIG. 2. For example, as described above, when a search query results in a very high degree of overlap in the same results across a number of different markets and/or domains, a very high ranking with respect to this signal may be returned by the signal ranker 220. On the other hand, a very low degree of overlap as evidenced by two marginally similar search results from two markets out of a large number of markets may result in a low signal ranking by the signal ranker 220.

At operation 345, each of the signal rankings generated for the results of operations 320, 325, 330, 335 are passed to the relevance score engine 230. A relevance score is generated for the received search query, as described above with reference to FIG. 2.

At operation 350, the signals generated for the received search query and the relevance score generated by the relevance score engine 230 are passed to the binary classifier 240 for classification and identification of the received search query as either a market-agnostic search query or a market-specific search query. As should be appreciated, and as described above, in some cases, the signals received, or lack thereof, for the received search query and the signal rankings and associated relevance score for the received search query may result in an inability of the binary classifier 240 to classify the received search query as either market-agnostic or market- specific. In such a case, manual intervention may be required by a developer of the search engine application 108 for either manually labeling the received search query or for using the received search query as both a market-agnostic search query or a market-specific search query where the classification for the search query is indeterminate.

According to alternative aspects, one or more of the processes described above with reference to operations 320, 325, 330, 335 (and as described with reference to FIG. 2), may not be required for identifying, classifying and/or labeling a search query as market-agnostic or market-specific. That is, all, some or a combination of the different operations 320, 325, 330, 335 may be used for identifying, classifying and/or labeling a search query. For example, a single operation 325 that determines that a search query includes an explicit location may be used for determining that the search query is a market-agnostic query without use of the other operations 320, 330, 335. Similarly, if a degree of overlap of search results among a great number of markets is significantly strong, the associated search query may be identified, classified and/or labeled as market-agnostic.

At operation 355, if the search query is classified as a market-agnostic or generic search query, an in-market query expansion may be performed to capture different forms of the same query which are valid for each market. The method 300 ends at operation 395. As illustrated and described herein, by classifying, identifying and labeling search queries as market-agnostic or market-specific, significant savings in data storage space, computing resources, and developer productivity may be achieved, as well as, speeding up the process by which new or modified search engine applications 108 may be shipped to market. By classifying and labeling a given search query as a market-agnostic search query, then new data generated for market-specific queries need only be generated, as described above.

As should be appreciated, examples described herein are for purposes of illustration and explanation. The examples described herein are not limiting of the vast numbers of search queries and results that may be entered and obtained via information searches as described herein.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are used for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. The operating system 405, for example, is suitable for controlling the operation of the computing device 400. Furthermore, aspects are practiced in conjunction with a graphics library, other operating systems, or any other application program, and is not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

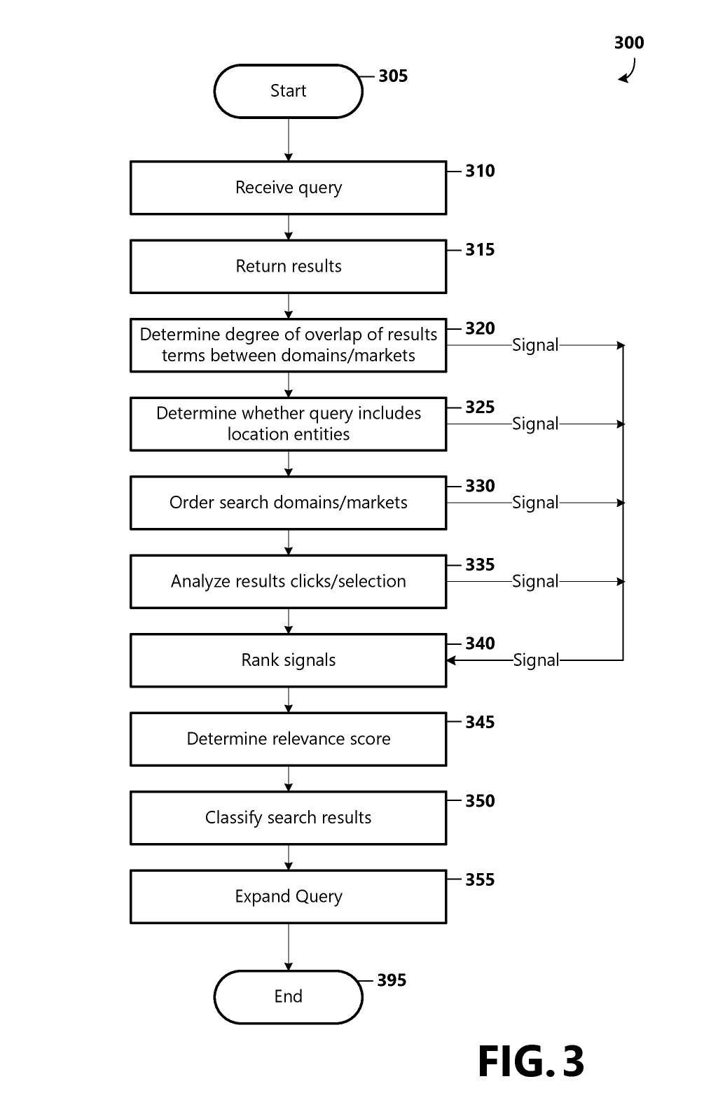

As stated above, according to an aspect, a number of program modules and data files are stored in the system memory 404. While executing on the processing unit 402, the program modules 406 (e.g., one or more components of the example search query identification system 110 (e.g., the search query identification system 110, the application 108)) perform processes including, but not limited to, one or more of the stages of the method 300 illustrated in FIGS. 3. According to an aspect, other program modules are used in accordance with examples and include applications such as search engine applications 108, electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 4 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 400 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media as used herein include computer storage media and computer storage devices. Computer storage media and computer storage devices include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

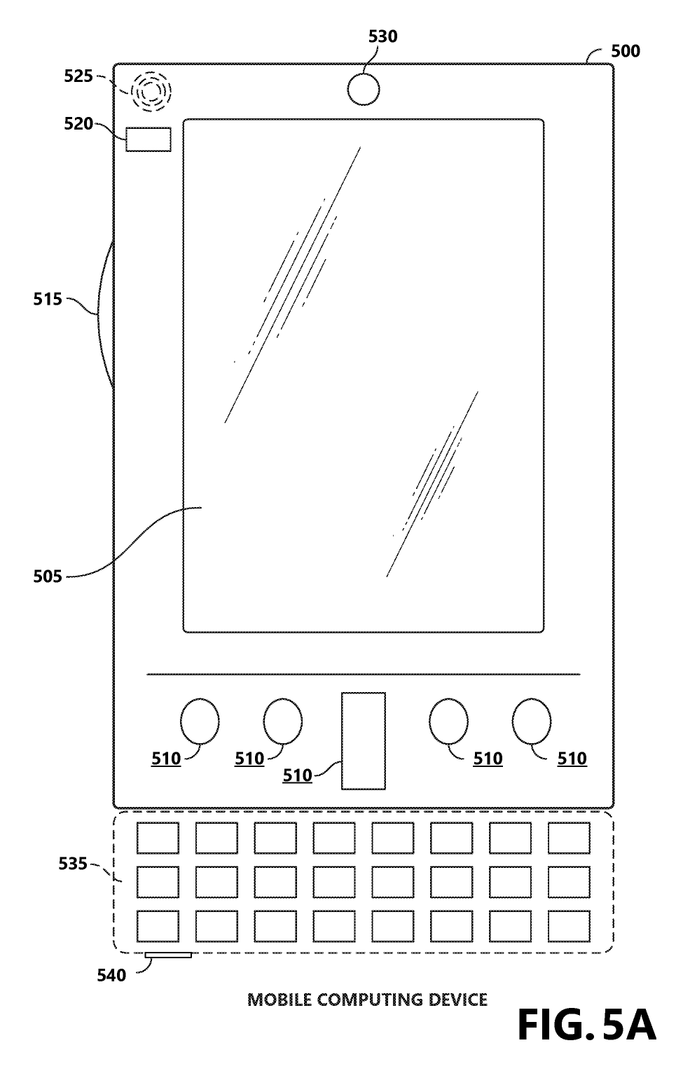

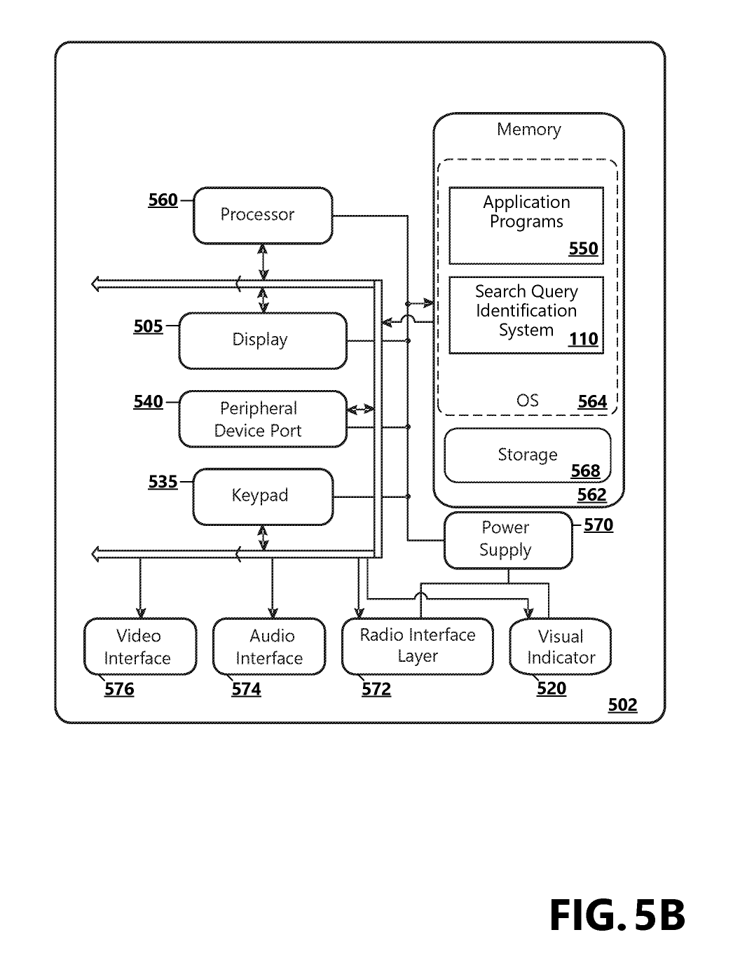

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or less input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. According to an aspect, one or more components of the example search query identification system 110 (e.g., the search query identification system 110 and the application 108) are loaded into memory 562. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as email or other messages used by an email application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 is stored locally on the mobile computing device 500, as described above. According to another aspect, the data is stored on any number of storage media that is accessible by the device via the radio 572 or via a wired connection between the mobile computing device 500 and a separate computing device associated with the mobile computing device 500, for example, a server computer in a distributed computing network, such as the Internet. As should be appreciated such data/information is accessible via the mobile computing device 500 via the radio 572 or via a distributed computing network. Similarly, according to an aspect, such data/information is readily transferred between computing devices for storage and use according to well-known data/information transfer and storage means, including electronic mail and collaborative data/information sharing systems.

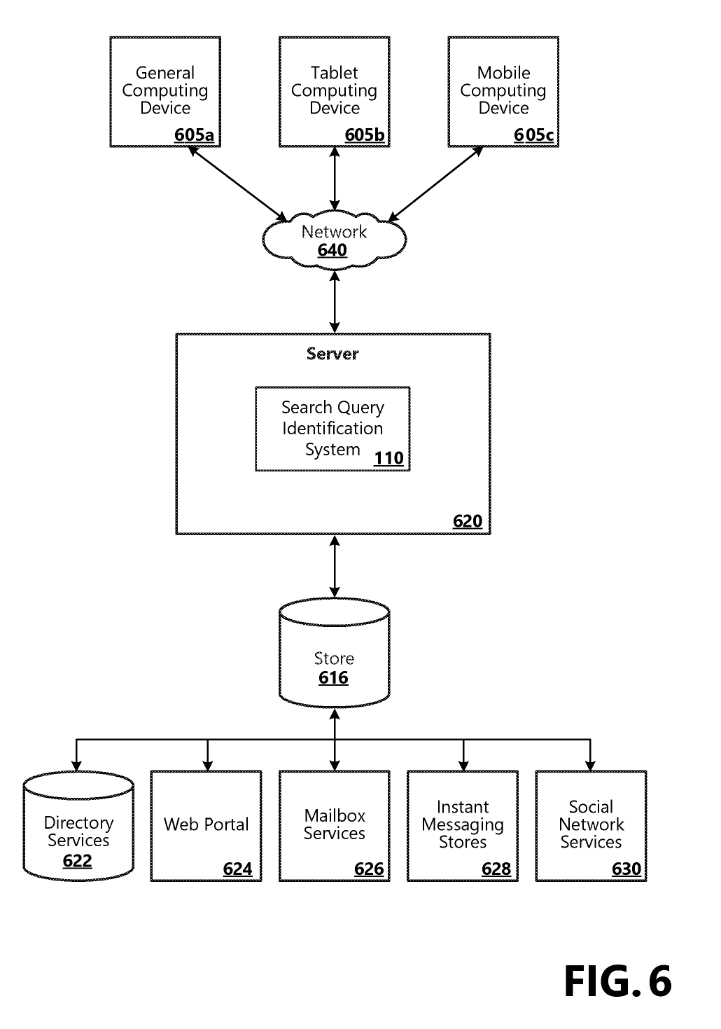

FIG. 6 illustrates one example of the architecture of a system for providing automatic identification and classification of market-agnostic and market-specific search queries, as described above. Content developed, interacted with, or edited in association with the one or more components of the example operating environment 100 is enabled to be stored in different communication channels or other storage types. For example, various documents may be stored using a directory service 622, a web portal 624, a mailbox service 626, an instant messaging store 628, or a social networking site 630. One or more components of the example search query identification system 110 are operative or configured to use any of these types of systems or the like for providing automatic identification and classification of market-agnostic and market-specific search queries, as described herein. According to an aspect, a server 620 provides the one or more components of the example search query identification system 110 to clients 605a,b,c. As one example, the server 620 is a web server providing one or more components of the example search query identification system 110 over the web. The server 620 provides one or more components of the example search query identification system 110 over the web to clients 605 through a network 640. By way of example, the client computing device is implemented and embodied in a personal computer 605a, a tablet computing device 605b or a mobile computing device 605c (e.g., a smart phone), or other computing device. Any of these examples of the client computing device are operable to obtain content from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method of identifying a market-agnostic search query, comprising:
receiving a search query;
determining one or more features of the received search query that indicate whether the search query is market-agnostic;
returning one or more search results in response to the search query;
determining one or more features of the one or more search results that indicate whether the search query is market-agnostic;
ranking the one or more features determined from the received search query and the one or more features determined from the one or more search results based on a strength of each of the features for indicating whether the search query is market-agnostic;
generating a relevance score based on each of the features rankings; and
if the relevance score for each of the features rankings meets a threshold relevance score for classifying the search query as market-agnostic, labeling the search query as market-agnostic.

2. The method of claim 1, further comprising if the search query is classified as market-agnostic, performing an in-market query expansion to capture one or more different forms of the search query, the one or more different forms being valid in one or more markets or domains.

3. The method of claim 1, wherein determining one or more features of the received search query that indicate the search query is market-agnostic further comprises:
determining whether the search query contains one or more location entities; and
wherein ranking the one or more features determined from the received search query includes ranking the one or more location entities for determining the strength of the one or more location entities for indicating the search query is market-agnostic.

4. The method of claim 1, wherein determining one or more features of the one or more search results that indicate the search query is market-agnostic further comprises:
determining a degree of overlap between search results returned from two or more different markets or search domains; and
wherein ranking the one or more features determined from the one or more search results includes ranking the degree of overlap for determining the strength of the degree of overlap for indicating the search query is market-agnostic.

5. The method of claim 1, wherein determining one or more features of the one or more search results that indicate the search query is market-agnostic further comprises:
if the one or more search results are returned from two or more search domains, ordering the two or more search domains in order of a domain prominence; and
wherein ranking the one or more features determined the one or more search results includes ranking the ordering of the two or more search domains for determining the strength of the ordering of the two or more search domains for indicating whether the search query is market-agnostic.

6. The method of claim 1, wherein determining one or more features of the one or more search results that indicate the search query is market-agnostic further comprises:
determining whether a user interaction with the one or more search results indicates the one or more search results are market-agnostic or market-specific; and
wherein ranking the one or more features determined the one or more search results includes ranking the user interaction with the one or more search results for determining the strength of the user interaction with the one or more search results for indicating whether the search query is market-agnostic.

7. The method of claim 1, wherein generating the relevance score based on each of the features rankings further comprises determining a relevance score for indicating a strength of classification of the search query as market-agnostic.

8. A method of classifying a search query, comprising:
receiving a search query;
returning one or more search results in response to the search query;
determining a degree of overlap between search results returned from two or more different markets or search domains;
determining whether the search query contains one or more location entities;
if the one or more search results are returned from two or more search domains, ordering the two or more search domains in order of domain prominence;
determining whether a user interaction with the one or more search results indicates the one or more search results are market-agnostic or market-specific;
determining a relevance score for the search query, the relevance score indicating a strength of classification of the search query as market-agnostic or as market-specific; and
classifying the search query as market-agnostic or as market-specific, based at least in part on the determined relevance score.

9. The method of claim 8, further comprising if the search query is classified as market-agnostic, performing an in-market query expansion to capture one or more different forms of the search query, the one or more different forms being valid in each of the two or more markets or search domains.

10. The method of claim 8, wherein receiving the search query includes receiving the search query at an Internet search engine application.

11. The method of claim 8, prior to returning one or more search results in response to the search query, running a search using the search query against a plurality of search domains for receiving the one or more search results from one or more markets.

12. The method of claim 8, further comprising:
after determining the degree of overlap, passing a first signal representing the degree of overlap to a signal ranker;
after determining whether the search query contains one or more location entities, passing a second signal representing the one or more location entities to the signal ranker;
after ordering the two or more search domains in order of the domain prominence, passing a third signal representing the domain prominence ordering to the signal ranker;
after determining whether the user interaction with the one or more search results indicates the one or more search results are market-agnostic or market-specific, passing a fourth signal representing the user interaction to the signal ranker.

13. The method of claim 12, further comprising ranking each of the first, second, third, and fourth signals based on their strength in being associated with either market-agnostic or market-specific.

14. The method of claim 13, further comprising determining a relevance score for the search query based on the rankings for each of the first, second, third and fourth signals, wherein the relevance score is used to classify the search query as market-agnostic or market-specific.

15. The method of claim 8, wherein the prior to determining whether the user interaction with the one or more search results indicates the one or more search results are market-agnostic or market-specific, receiving a user selection of the one or more search results.

16. The method of claim 8, prior to determining whether the user interaction with the one or more search results indicates the one or more search results are market-agnostic or market-specific, receiving a click on the one or more search results.

17. The method of claim 8, wherein determining whether the user interaction with the one or more search results indicates the one or more search results are market-agnostic or market-specific includes receiving a user dwell time after a user selects an of the one or more search results.

18. A system for identifying a search query as market-agnostic or market-specific, comprising:
at least one processing device;
at least one computer readable data storage device storing instructions that, when executed by the at least one processing device, cause the system to provide:
a search engine configured to:
receive a search query; and
return one or more search results in response to the search query;
a search results analyzer configured to:
determine a degree of overlap between search results returned from two or more different markets or search domains;
determine whether the search query contains one or more location entities;
order two or more search domains in order of a domain prominence if the one or more search results are returned from the two or more search domains; and
determine whether a user interaction with the one or more
search results indicates the one or more search results are market-agnostic or market-specific;
a relevance score engine configured to:
determine a relevance score for the search query, the relevance score indicating a strength of classification of the search query as market-agnostic or as market-specific; and
a binary classifier configured to:
classify the search query as market-agnostic or as market-specific, based at least in part on the relevance score determined by the relevance score engine.

19. The system of claim 18, further comprising
a signal ranker configured to:
rank one or more features determined from the received search query and one or more features determined from the one or more search results based on a strength of each of the features for indicating the search query is market-agnostic or market-specific; and
the relevance score engine being further configured to:
determine the relevance score for the search query based on a ranking of each of the one or more features determined from the received search query and each of the one or more features determined from the one or more search results.

20. The system of claim 18, being further configured to perform an in-market query expansion to capture one or more different forms of the search query if the search query is classified as market-agnostic, the one or more different forms being valid in one or more markets or domains.
